(19) United States
(12) Patent Application Publication
(10) Pub. No.: US 2013/0044468 A1
(43) Pub. Date: Feb. 21, 2013

(54) LED LIGHT BAR STRUCTURE

(71) Applicants: KANG-YU LAI, Taichung City (TW); SHIN-CHANG CHEN, Jincheng Township (TW)

(72) Inventors: KANG-YU LAI, Taichung City (TW); SHIN-CHANG CHEN, Jincheng Township (TW)

(73) Assignee: Chunghwa Pictures Tubes, LTD., Bade City (TW)

(21) Appl. No.: 13/288,938

(22) Filed: Nov. 3, 2011

(30) Foreign Application Priority Data
Aug. 17, 2011 (TW) 100215320

(51) Int. Cl. F21V 7/00; F21V 21/00

(52) U.S. Cl. 362/217.05; 362/217.14

(57) ABSTRACT

The present invention discloses an LED light bar structure, which includes at least one LED and a circuit board. Each LED has two or an even number of pins. The circuit board has at least one receiving space and at least two recesses, in which the LED is disposed in the receiving space, and each of the pins is engaged in the recess. The present invention solves drawbacks of the LED shifting when being conventionally welded and the LED is difficult to replace.

### TECHNICAL FIELD OF THE INVENTION

The present invention relates to a light bar structure, and especially to an LED light bar structure.

### BACKGROUND OF THE INVENTION

Light Emitting Diodes (LEDs) have advantages of long life, high light efficiency, and energy saving, so the LEDs are gradually utilized as a backlight source of an LCD. Referring to FIG. 1, FIG. 1 is a schematic drawing illustrating a conventional light bar structure used in an edge-lit backlight module. The conventional light bar structure has a plurality of LEDs 25 being welded on a circuit board 40. The circuit board 40 has contact pads 42 corresponding to pins 27 of the LEDs 25, and the LEDs 25 are electrically coupled to wires (not shown) via the contact pads 42, so as to receive external electric power.

In general, the way of welding the LEDs 25 onto the circuit board 40 is by stamping the pins 27 of the LEDs 25 on the contact pads 42 having soldering tin thereon to slightly fix the LEDs 25 on the circuit board 40 and then to put into a hot oven to melt the soldering tin between the pins 27 and the contact pads 42. After cooling, the pins 27 and the contact pads 42 are connected together, thereby completing the welding process.

However, the LEDs 25 may shift in the soldering tin melting process such that the pins 27 fail to align with the contact pads 42. Moreover, the material of the LEDs 25 may experience a chemical change after being processed by the high temperature, so that optical properties such as chromaticity or brightness of the LEDs 25 are changed and fail to achieve the desired optical effects. In addition, if some LEDs 25 are broken, the broken LEDs 25 can be replaced by removing the LEDs 25 through a special solvent with a welding torch. However, the original optical properties of the LEDs 25 are easy to be changed by the high temperature during the contact of the welding torch and further to affect the optical properties of the backlight module.

### SUMMARY OF THE INVENTION

Accordingly, an objective of the present invention is to provide an LED light bar structure to solve the above-mentioned problem by using an engaging structure to replace welding.

To achieve the foregoing objectives, according to an aspect of the present invention, the LED light bar structure provided by the present invention includes at least one LED, a circuit board, and a plurality of wires. Each LED has two or an even number of pins. The circuit board has at least one receiving space and at least two recesses, in which the LED is disposed in the receiving space, and each of the pins is engaged in a corresponding one of the recesses. The wires are disposed in the circuit board, and the wires are electrically coupled to the pins of the LED, respectively.

In one preferred embodiment, each LED has a light-emitting surface, and the light-emitting surface is exposed outside the corresponding receiving space. The light bar structure according to the preferred embodiment further includes a reflector, which the reflector are disposed on the circuit board. The reflector defines at least one opening corresponding to the at least one light-emitting surface for exposing the at least one light-emitting surface of the LED. More specifically, the reflector is utilized to fix the LED into the receiving space.

In another preferred embodiment, the light bar structure further includes at least one elastic bump, and the elastic bump is disposed in the recess to clamp each of the pins engaged in the recess.

In another preferred embodiment, the recess is inclined with respect to a direction of the pin to be inserted into the receiving space, thereby the pin being bent after being inserted into the recess.

In another preferred embodiment, one of the recesses is an arch-shaped ditch for each LED. The LED is rotatably disposed in the receiving space, and one of the pins of the LED is engaged in one end of the arch-shaped ditch.

In accordance with the design of the receiving space and the recess in the circuit board, the LED can be easily fixed on the circuit board with an advantages of easy replacement. Therefore, the present invention overcomes drawbacks of the LEDs shifting when being welded by means of the conventional welding and the material change of the LEDs at high temperature, and further overcomes that the LEDs have to be replaced by de-soldering the LEDs.

It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1 is a schematic drawing illustrating a conventional light bar structure used in an edge-lit backlight module;

FIG. 2 is a top view schematically illustrating an LED light bar structure according to a first preferred embodiment of the present invention;

FIG. 3 is a schematic cross-sectional diagram along A-A′ in FIG. 2;

FIG. 4 is a schematic cross-sectional diagram illustrating an LED light bar structure according to another aspect of the first preferred embodiment;

FIG. 5 is a partial cross-sectional diagram illustrating a light bar structure according to the second preferred embodiment of the present invention;

FIG. 6 is a partial cross-sectional diagram illustrating a light bar structure according to the third preferred embodiment of the present invention;

FIG. 7 is a partial cross-sectional diagram illustrating a light bar structure according to another aspect of the third preferred embodiment of the present invention;

FIG. 8 is a partial perspective view illustrating a light bar structure according to the fourth preferred embodiment of the present invention; and

FIG. 9 is a partial perspective view illustrating the LED of FIG. 8 being rotated to engage in an arch-shaped ditch.

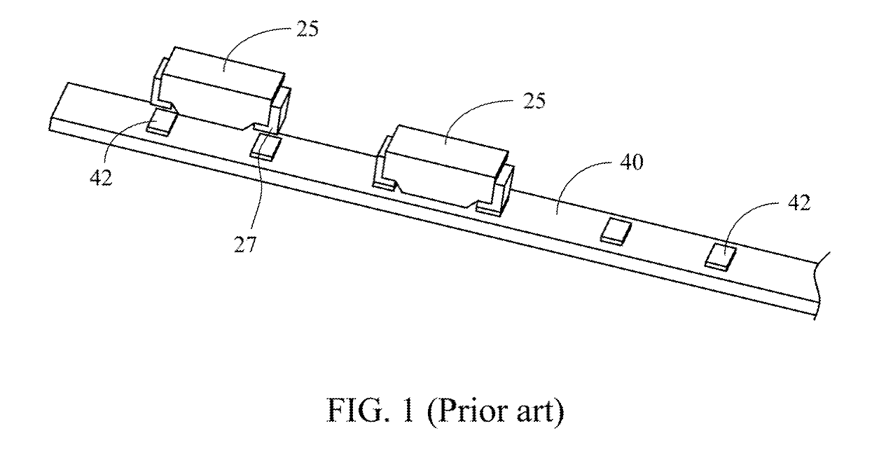

### DETAILED DESCRIPTION OF THE INVENTION

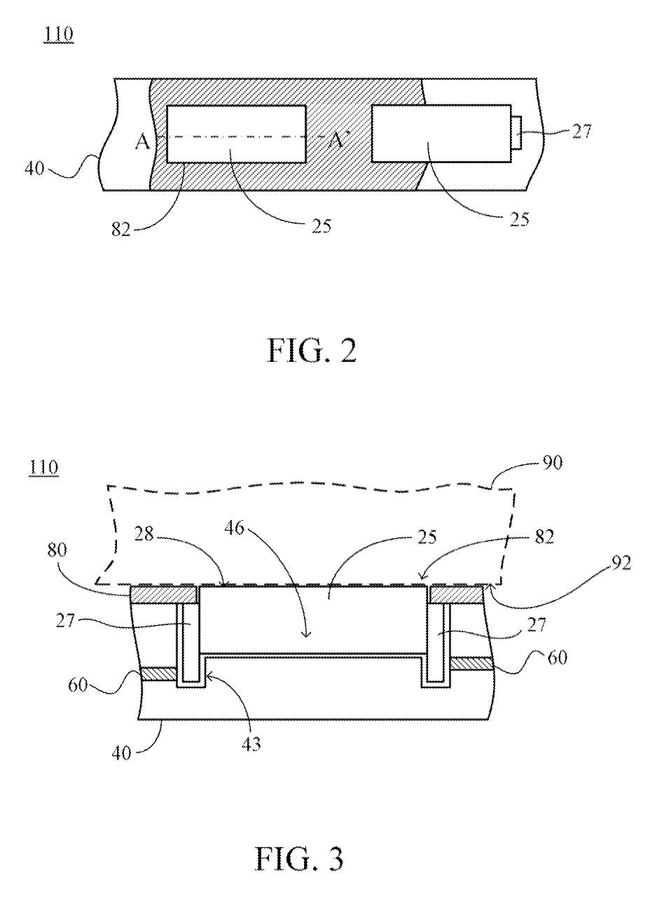

The present invention will now be described in detail with reference to a preferred embodiment , thereof as illustrated in the accompanying drawings . In different drawings the same reference numbers will be used throughout the drawings to refer to the same or like parts. Referring to FIG. 2 and FIG. 3, FIG. 2 is a top view schematically illustrating an LED light bar structure according to a first preferred embodiment of the present invention, and FIG. 3 is a schematic cross-sectional diagram along A-A′ in FIG. 2. The LED light bar structure according to the first preferred embodiment of the present invention is generally designated at 110, hereinafter referred to as the light bar structure 110. The LED light bar structure 110 includes at least one LED 25, a circuit board 40, and a plurality of wires 60.

Each LED 25 has two pins 27. However, the pins of each LED 25 also can be four or an even number of pins, and the present invention does not limited the number of the pins. As shown in FIG. 3, the circuit board 40 has at least one receiving space 46 and at least two recesses 43 corresponding to the LEDs 25, in which the LED 25 is disposed in the receiving space 46, and each of the pins 27 is engaged in a corresponding one of the recesses 43. The wires 60 are disposed in the circuit board 40 and electrically coupled to the pins 27 of the LED 25 for providing external electrical power. It should be noted that positions of the wires 60 exposing do not limited in the present invention, and the wires that can respectively be disposed at different layers of the circuit board 40 can be adjusted as desired.

It is worth mentioning that each of the LED 25 has a light-emitting surface 28, and the light-emitting surface 28 is exposed outside the corresponding receiving space 46 to emit light. In the first preferred embodiment, the light bar structure 110 further includes a reflector 80. The reflector 80 are disposed on the circuit board 40, and the reflector 80 defines at least one opening 82 corresponding to the at least one light-emitting surface 28 for exposing the light-emitting surface 28. The reflector 80 is utilized to fix the LED into the receiving space 46. More specifically, the reflector 80 can resist against one end of the pin 27 for fixing the pin 27 in the recess 43.

In addition to the effect of fixing the LED 25, the reflector 80 has an effect of reflecting the light from the LED 25 for increasing light utilization efficiency. Moreover, the light bar structure 110 is held against an incident surface 92 of a light guide plate 90 in a top-view LED backlight module, so the reflector 80 can fill the gap between the LED 25 and the light guide plate 90 to strengthen the assemble therebetween.

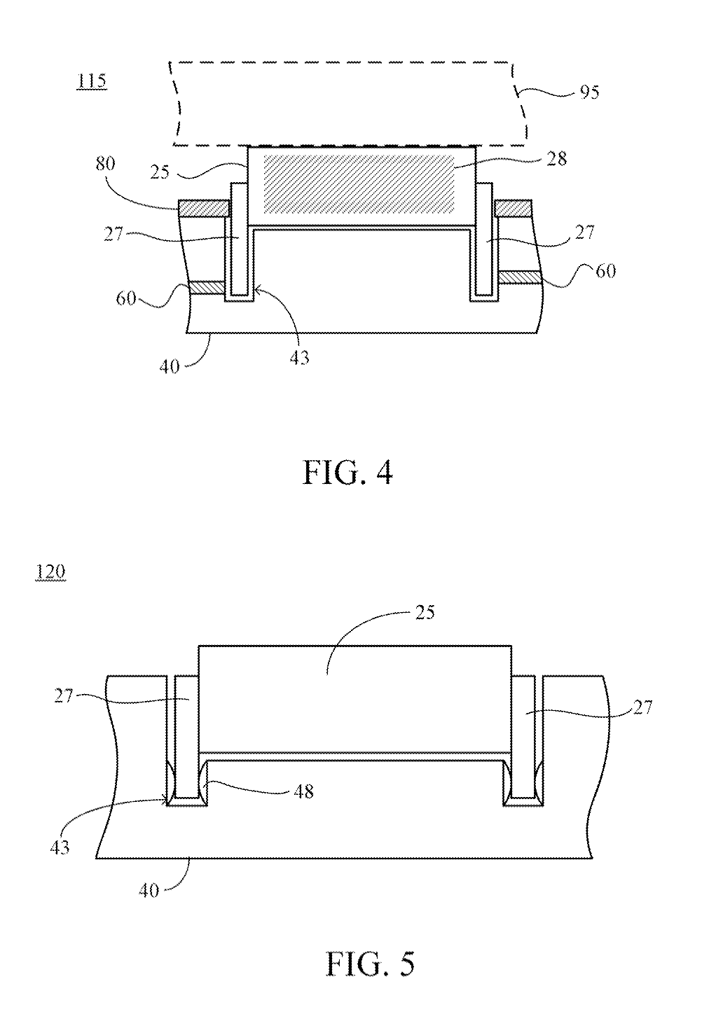

Referring to FIG. 4, FIG. 4 is a schematic cross-sectional diagram illustrating an LED light bar structure according to another aspect of the first preferred embodiment, in which the LED light bar structure according to the aspect of the first preferred embodiment is generally designated at 115. The light bar structure 115 is a light bar structure used in a side-view LED backlight module. One difference from the above-mentioned aspect is that the LEDs 25 of the aspect are side-view LEDs, that is, the light-emitting surface 28 of the LED 25 is perpendicular to the reflector 80 and is located out of the circuit board 40. In the aspect of the first preferred embodiment, a mold frame 95 of the side-view LED backlight module can fix the LEDs 25.

A second preferred embodiment of the present invention will be explained in the following. Referring to FIG. 5, FIG. 5 is a partial cross-sectional diagram illustrating a light bar structure according to the second preferred embodiment of the present invention, in which the LED light bar structure according to the second preferred embodiment is generally designated at 120. The descriptions of the same elements in the first embodiment have been explained as above mention, so no further detail will be provided herein. The light bar structure 120 of the second embodiment further includes a plurality of elastic bumps 48, and the elastic bumps 48 are disposed in each recess 43 to clamp the corresponding pins 27. Preferably, two elastic bumps 48 are respectively disposed both sides of the recess 43 to clamp more firmly.

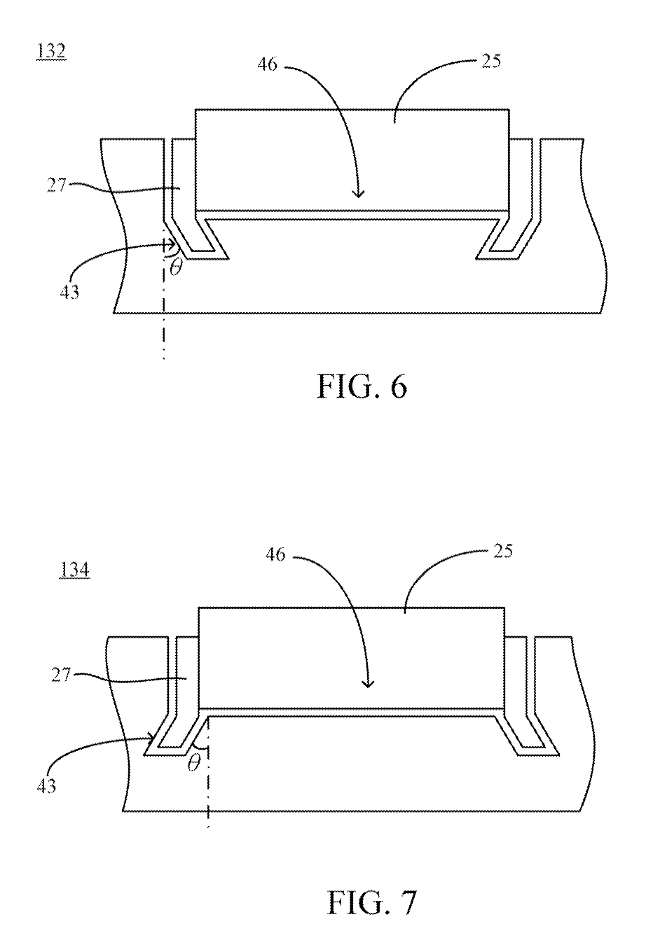

A third preferred embodiment of the present invention will be explained in the following. Referring to FIG. 6 and FIG. 7, FIG. 6 is a partial cross-sectional diagram illustrating a light bar structure according to the third preferred embodiment of the present invention, and FIG. 7 is a partial cross-sectional diagram illustrating a light bar structure according to another aspect of the third preferred embodiment of the present invention. The LED light bar structure according to one aspect of the third preferred embodiment is generally designated at 132, and the LED light bar structure according to another aspect of the third preferred embodiment is generally designated at 134. In the third preferred embodiment, the recess 43 has a predetermined angle θ with respect to a direction (as the dashed line shown) of the LED 25 being inserted into the receiving space 46 so that the pins 27 are bent after being inserted into the recess 43, and the LED 25 is fixed in the receiving space 46 through the bend pins 27.

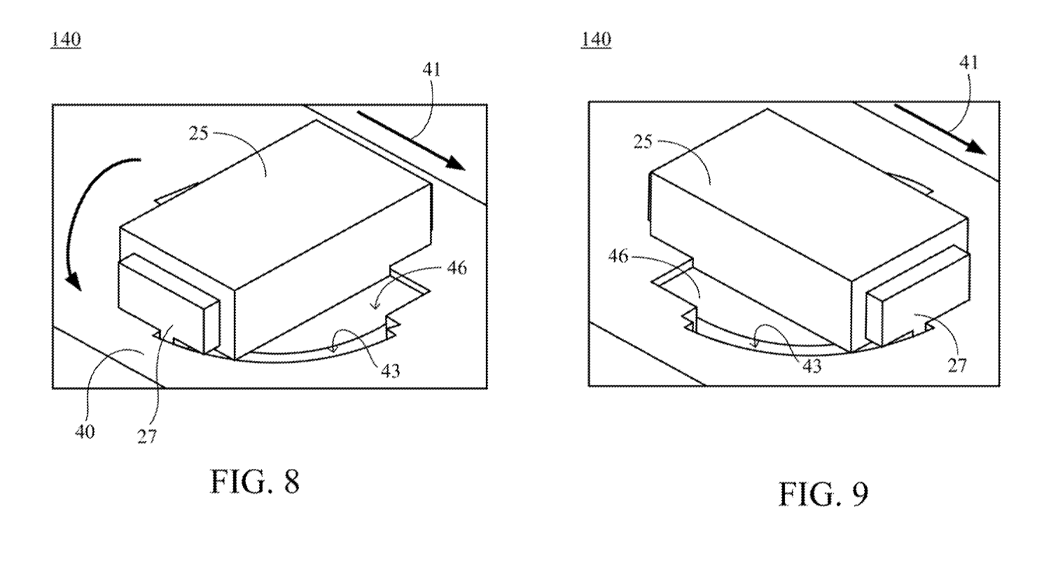

A fourth preferred embodiment of the present invention will be explained in the following. Referring to FIG. 8 and FIG. 9, FIG. 8 is a partial perspective view illustrating a light bar structure according to the fourth preferred embodiment of the present invention, and FIG. 9 is a partial perspective view illustrating the LED 25 of FIG. 8 being rotated to engage in an arch-shaped ditch, in which the LED light bar structure according to one aspect of the fourth preferred embodiment is generally designated at 140. As shown in FIG. 8, one of the recesses 43 is an arch-shaped ditch for each LED in the fourth preferred embodiment. The LED 25 is rotatably disposed in the receiving space 46, and one of the pins for each LED is engaged in one end of the arch-shaped ditch, as shown in FIG. 9.

The following will explain assembly processes of the light bar structure 140 in the fourth preferred embodiment. A first step of the assembly processes includes insert one of the pins 27 into one end of the arch-shaped ditch when disposing the LED 25 into the receiving space 46 of the circuit board 40; meanwhile, a direction of the LED 25 is perpendicular to the direction 41 of the circuit board 40. Then a second step thereof includes rotate the LED 25 counterclockwise to make the pin 27 to engage in another end of the arch-shaped ditch (as FIG. 9 shown), so that the LED 25 is fixed on the circuit board 40 as a correct position.

In summary, in accordance with the design of the receiving space 46 and the recess 43 in the circuit board 40, the LED 25 can be easily fixed on the circuit board 40 with an advantages of easy replacement. Therefore, the present invention overcomes the drawbacks of the shift of the LEDs 25 in using the conventional welding and the material change of the LEDs 25 at high temperature, and further overcomes that the LEDs 25 have to be replaced by de-soldering the LEDs 25.

While the preferred embodiments of the present invention have been illustrated and described in detail, various modifications and alterations can be made by persons skilled in this art. The embodiment of the present invention is therefore described in an illustrative but not restrictive sense.

What is claimed is:

1. A Light Emitting Diode (LED) light bar structure, comprising:
at least one LED, each LED having two pins; and
a circuit board, having at least one receiving space and at least two recesses, wherein the LED is disposed in the receiving space, and each of the pins is engaged in a corresponding one of the recesses.

2. The LED light bar structure of claim 1, further comprising a plurality of wires disposed in the circuit board, wherein the wires are electrically coupled to the pins of the LED, respectively.

3. The LED light bar structure of claim 1, wherein each LED has a light-emitting surface, and the light-emitting surface is exposed outside the corresponding receiving space.

4. The LED light bar structure of claim 3, further comprising a reflector disposed on the circuit board, wherein the reflector defines at least one opening corresponding to each light-emitting surface for exposing the light-emitting surface of the LED.

5. The LED light bar structure of claim 4, wherein the reflector is utilized to fix the LED into the receiving space.

6. The LED light bar structure of claim 1, further comprising at least one elastic bump, wherein the elastic bump is disposed in the recess to clamp each of the pins engaged in the recess.

7. The LED light bar structure of claim 1, wherein the recess is inclined with respect to a direction of the pin to be inserted into the receiving space, thereby the pin being bent after being inserted into the recess.

8. The LED light bar structure of claim 1, wherein for each LED, one of the recesses is an arch-shaped ditch.

9. The LED light bar structure of claim 8, wherein the LED is rotatably disposed in the receiving space.

10. The LED light bar structure of claim 8, wherein one of the pins of the LED is engaged in one end of the arch-shaped ditch.
